(19) United States
(12) Patent Application Publication
(10) Pub. No.: US 2025/0309296 A1
(43) Pub. Date: Oct. 2, 2025

(54) FUEL CELL SYSTEM AND METHOD OF CONTROLLING SAME

(71) Applicants: Hyundai Motor Company, Seoul (KR); Kia Corporation, Seoul (KR)

(72) Inventors: Sun Ki Rhee, Hwaseong-Si (KR); Dae Nyung Lee, Hwaseong-Si (KR); Jun Young Park, Hwaseong-Si (KR); Young Jin Jung, Hwaseong-Si (KR); Seung Yoon Lee, Hwaseong-Si (KR); Min Ju Park, Hwaseong-Si (KR)

(21) Appl. No.: 18/964,148

(22) Filed: Nov. 29, 2024

(30) Foreign Application Priority Data
Apr. 1, 2024 (KR) 10-2024-0044342

(51) Int. Cl. H01M 8/04223; B60L 50/70; B60L 58/31; H01M 8/04082; H01M 8/04225; H01M 8/04302; H01M 8/0438; H01M 8/0444; H01M 8/04537; H01M 8/04746; H01M 8/04992

(52) U.S. Cl. CPC H01M 8/04231; H01M 8/04201; H01M 8/04225; H01M 8/04302; H01M 8/04388; H01M 8/04447; H01M 8/04544; H01M 8/04574; H01M 8/04753; H01M 8/04992; B60L 50/70; B60L 58/31; H01M 2250/20

(57) ABSTRACT

A system and a method of controlling the fuel system are introduced. The fuel cell system may comprise a hydrogen tank configured to store hydrogen a fuel cell configured to receive, based on a state of the hydrogen tank, the hydrogen from the hydrogen tank a sensor configured to measure at least one of an output current or an output voltage of the fuel cell and a processor configured to determine the state of the hydrogen tank, wherein the state is associated with an amount of hydrogen filled in the hydrogen tank determine, based on the output voltage of the fuel cell, a purity level of the hydrogen stored in the hydrogen tank, wherein the output voltage is obtained based on the state of the hydrogen tank and open, based on the purity level of the hydrogen being unsatisfactory, a purge valve for discharging residual hydrogen from the fuel cell.

### CROSS-REFERENCE TO RELATED APPLICATION

This application claims the benefit of priority to Korean Patent Application No. 10-2024-0044342, filed in the Korean Intellectual Property Office on Apr. 1, 2024, the entire contents of which are incorporated herein by reference.

### TECHNICAL FIELD

The present disclosure relates to a fuel cell system and a method of controlling the same, and more particularly, relate to improve problems caused by poor purity of hydrogen of a fuel cell system.

### BACKGROUND

The matters described in this Background section are only for enhancement of understanding of the background of the disclosure, and should not be taken as acknowledgement that they correspond to prior art already known to those skilled in the art.

Hydrogen electric vehicles are driven using electrical energy generated by fuel cells. Fuel cells produce electricity using a chemical reaction between hydrogen and oxygen and provide the produced electrical energy to a driving motor.

Hydrogen and oxygen are used for the chemical reaction of the fuel cell, and hydrogen stored in a hydrogen tank of a vehicle is used as the hydrogen for the chemical reaction. The chemical reaction of the fuel cell may be operated based on a preset hydrogen purity, and if the hydrogen purity is decreased, output of the fuel cell may become unstable. In the hydrogen electric vehicles, if the output of the fuel cell is unstable, an output current of the fuel cell is limited, and if the output of the fuel cell is continuously unstable, a fuel cell system is shut down. That is, if the purity of hydrogen supplied to the fuel cell is low, the fuel cell may be shut down, and durability of the fuel cell may be reduced.

In this way, if the purity of the hydrogen supplied to the fuel cell is low, the fuel cell system may be shut down regardless of intention of a driver or the durability of the fuel cell may be reduced.

### SUMMARY

According to the present disclosure, a fuel cell system may comprise a hydrogen tank configured to store hydrogen a fuel cell configured to receive, based on a state of the hydrogen tank, the hydrogen from the hydrogen tank a sensor configured to measure at least one of an output current or an output voltage of the fuel cell and a processor configured to determine the state of the hydrogen tank, wherein the state is associated with an amount of hydrogen filled in the hydrogen tank determine, based on the output voltage of the fuel cell, a purity level of the hydrogen stored in the hydrogen tank, wherein the output voltage is obtained based on the state of the hydrogen tank and open, based on the purity level of the hydrogen being unsatisfactory, a purge valve for discharging residual hydrogen from the fuel cell.

The fuel cell system, wherein the processor is configured to determine, based on a start-up signal of a vehicle, a pressure of the hydrogen tank and determine, based on a difference between the pressure of the hydrogen tank and a pressure of the hydrogen tank before the start-up signal being greater than or equal to a threshold pressure, the state of the hydrogen tank.

The fuel cell system, wherein the processor is configured to after a start-up signal of a vehicle, determine the output current of the fuel cell and the output voltage of the fuel cell and determine, based on a difference between the output voltage of the fuel cell and a reference voltage being smaller than or equal to a threshold voltage, the purity level of the hydrogen as being unsatisfactory.

The fuel cell system, wherein the processor is configured to determine a last driving period of the fuel cell before the start-up signal as a reference driving period determine an aging degree of the fuel cell within the reference driving period as a reference aging degree acquire a reference current-voltage relationship by modeling, based on the reference aging degree, a current-voltage relationship of the fuel cell and determine, based on the reference current-voltage relationship, the reference voltage, wherein the reference voltage is a voltage matched with a magnitude of the output current of the fuel cell after the start-up signal.

The fuel cell system, wherein the threshold voltage is greater than a voltage difference between an initial voltage at an initial timing a lifetime of the fuel cell and a termination voltage at a termination timing of the lifetime of the fuel cell.

The fuel cell system, wherein the processor is configured to determine, based on a voltage difference between the output voltage of the fuel cell and the reference voltage, a ratio of an open period of the purge valve to a closed period of the purge valve.

The fuel cell system, wherein the processor is configured to increase the ratio of the open period in proportion to a vehicle speed.

The fuel cell system, wherein the processor is configured to monitor a cell voltage ratio of a magnitude of a minimum cell voltage of the fuel cell to a magnitude of an average cell voltage of the fuel cell and reduce, based on the cell voltage ratio being greater than or equal to a reference ratio, the ratio of the open period.

The fuel cell system, wherein the processor is configured to in a first state in which the purge valve is open, determine a first cell voltage ratio of a magnitude of a minimum cell voltage of the fuel cell to a magnitude of an average cell voltage of the fuel cell in a second state in which the purge valve is closed, determine a second cell voltage ratio of a magnitude of a minimum cell voltage of the fuel cell to a magnitude of an average cell voltage of the fuel cell and determine, based on a difference between the first cell voltage ratio and the second cell voltage ratio being greater than or equal to a threshold value, the purity level of the hydrogen as being unsatisfactory.

The fuel cell system, wherein the processor is configured to determine, based on a ratio of a magnitude of a minimum cell voltage of the fuel cell to a magnitude of an average cell voltage of the fuel cell, whether the fuel cell is degraded and maintain, based on the fuel cell being degraded, the purge valve in a closed state.

The fuel cell system, wherein the processor is configured to maintain, based on the output current of the fuel cell being smaller than or equal to a threshold output, the purge valve in a closed state.

According to the present disclosure, a method performed by a processor for controlling a fuel cell system, the method may comprise determining a state of a hydrogen tank, wherein the state is associated with an amount of hydrogen filled in the hydrogen tank determining, based on an output voltage of a fuel cell, a purity level of the hydrogen stored in the hydrogen tank, wherein the output voltage is obtained based on the state of the hydrogen tank and opening, based on the purity level of the hydrogen being unsatisfactory, a purge valve for discharging residual hydrogen from the fuel cell.

The method, wherein the determining the purity level of the hydrogen may comprise after a start-up signal of a vehicle, determining the output current of the fuel cell and an output voltage of the fuel cell and determining, based on a difference between the output voltage of the fuel cell and a reference voltage being smaller than or equal to a threshold voltage, the purity level of the hydrogen as being unsatisfactory.

The method, wherein the determining the purity level of the hydrogen may further comprise determining a last driving period of the fuel cell before the start-up signal as a reference driving period determining an aging degree of the fuel cell within the reference driving period as a reference aging degree acquiring a reference current-voltage relationship by modeling, based on the reference aging degree, a current-voltage relationship of the fuel cell and determining, based on the reference current-voltage relationship, the reference voltage, wherein the reference voltage is a voltage matched with a magnitude of the output current of the fuel cell after the start-up signal.

The method, wherein the threshold voltage is greater than a voltage difference between an initial voltage at an initial timing of a lifetime of the fuel cell and a termination voltage at a termination timing of the lifetime of the fuel cell is used.

The method, wherein the opening the purge valve may comprise determining, based on a voltage difference between the output voltage of the fuel cell and the reference voltage, a ratio of an open period of the purge valve to a closed period of the purge valve.

The method, wherein the determining the purity level of the hydrogen may comprise in a first state in which the purge valve is open, determining a first cell voltage ratio of a magnitude of a minimum cell voltage of the fuel cell to a magnitude of an average cell voltage of the fuel cell in a second state in which the purge valve is closed, determining a second cell voltage ratio of a magnitude of a minimum cell voltage of the fuel cell to a magnitude of an average cell voltage of the fuel cell and determining, based on a difference between the first cell voltage ratio and the second cell voltage ratio being greater than or equal to a threshold value, the purity level of the hydrogen as being unsatisfactory.

The method, wherein the opening the purge valve may comprise determining, based on a difference between the first cell voltage ratio and the second cell voltage ratio, a ratio of an open period of the purge valve to a closed period of the purge valve.

The method may further comprise determining, based on a ratio of a magnitude of a minimum cell voltage of the fuel cell to a magnitude of an average cell voltage of the fuel cell, whether the fuel cell is degraded and maintaining, based on the fuel cell being degraded, the purge valve in a closed state.

The method may further comprise determining an output current of the fuel cell and maintaining, based on the output current of the fuel cell being smaller than or equal to a threshold output, the purge valve in a closed state.

### BRIEF DESCRIPTION OF THE DRAWINGS

The above and other objects, features and advantages of the present disclosure will be more apparent from the following detailed description taken in conjunction with the accompanying drawings:

FIG. 1 shows an example of a fuel cell system according to an example of the present disclosure;

FIG. 2 shows an example of a method of controlling the fuel cell system according to the example of the present disclosure;

FIG. 3 shows an example of a method of controlling a fuel cell system according to another example of the present disclosure;

FIG. 4 shows an example of determining the purity of hydrogen based on an output voltage of a fuel cell;

FIG. 5 shows an example of an open ratio of a purge valve according to the example of the present disclosure;

FIG. 6 shows an example of the method of controlling the fuel cell system according to another example of the present disclosure; and

FIG. 7 shows an example of a computing system according to the example of the present disclosure.

### DETAILED DESCRIPTION

Hereinafter, some examples of the present disclosure will be described in detail with reference to the exemplary drawings.

In adding reference numerals to components of each drawing, it should be noted that identical or equivalent components are designated by an identical numeral even when they are displayed on other drawings. Further, in describing the example of the present disclosure, a detailed description of the related known configuration or function will be omitted if it is determined that the detailed description interferes with the understanding of the example of the present disclosure.

In the description of the components of the examples of the present disclosure, terms such as first, second, A, B, (a) and (b) may be used. These terms are merely intended to distinguish one component from other components, and the terms do not limit the nature, order, or sequence of the components. Unless otherwise defined, all terms including technical and scientific terms used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

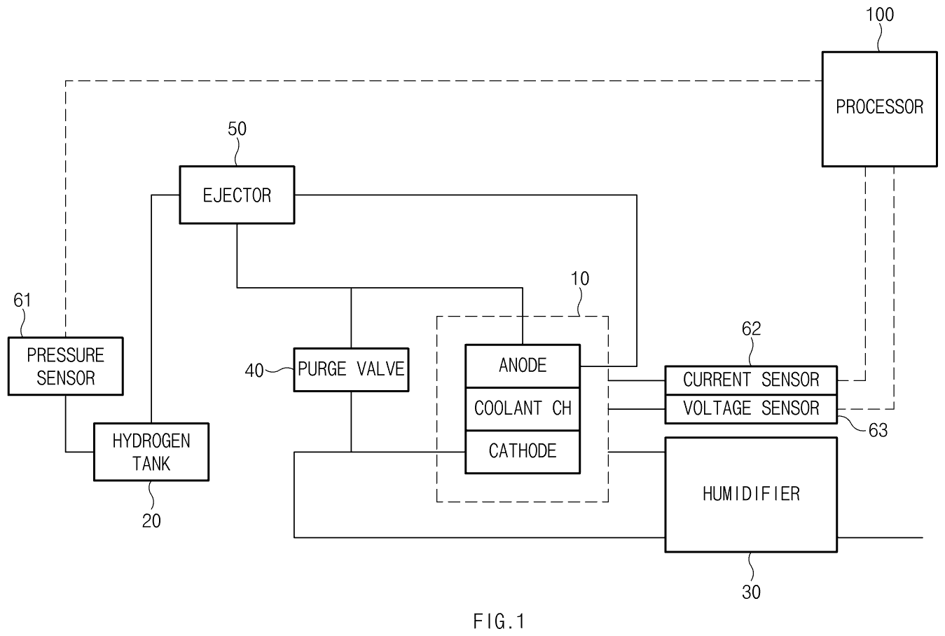

Hereinafter, examples of the present disclosure will be described in detail with reference to FIGS. 1 to 7.

FIG. 1 shows an example of a fuel cell system according to an example of the present disclosure.

Referring to FIG. 1, the fuel cell system according to the example of the present disclosure, which is adapted to generate energy for a hydrogen electric vehicle, may include a fuel cell 10, a hydrogen tank 20, a humidifier 30, a purge valve 40, an ejector 50, sensor devices 61, 62, and 63, and a processor 100.

The fuel cell 10 may be adapted to generate electrical energy using an electrochemical reaction between hydrogen and oxygen. The fuel cell 10 may include a plurality of cells. The cells of the fuel cell 10 may include a membrane-electrode assembly (MEA) that oxidizes/reduces the hydrogen and air inside an end plate.

The hydrogen tank 20 may be adapted to store the hydrogen supplied to the fuel cell 10.

The humidifier 30 may be adapted to maintain the air provided from the outside at an appropriate humidity. The air passing through the humidifier 30 may react with the hydrogen at an anode via a cathode of the fuel cell 10.

The purge valve 40 may be adapted to discharge residual hydrogen and/or moisture in the fuel cell 10. The purge valve 40 may be used to perform purging. The purging may prevent the build-up of unreacted hydrogen and/or oxygen within the fuel cell 10, which may lead to inefficiencies or hazardous conditions, to avoid water build-up, which may block gas flow channels and reduce the performance of the fuel cell 10, to ensure the fuel cell 10 operates at optimal efficiency by providing a clean environment for the chemical reactions, to protect fuel cell components from degradation that may occur due to residual gases and/or moisture.

The ejector 50 may be adapted to supply the hydrogen stored in the hydrogen tank 20 to the fuel cell 10.

The sensor devices 61, 62, and 63 may include the pressure sensor 61, the current sensor 62, and the voltage sensor 63. The pressure sensor 61 may be adapted to measure a pressure (e.g., 35-70 megapascal (MPa)) of the hydrogen tank 20. Further, the pressure sensor 61 may be formed in a pipe connecting the ejector 50 and the fuel cell 10 to measure a pressure of the hydrogen provided to the fuel cell 10. The current sensor 62 may be adapted to measure an output current of the fuel cell 10, and the voltage sensor 63 may be adapted to measure a voltage of the fuel cell 10.

The processor 100 may determine whether the hydrogen tank 20 is filled with the hydrogen and determine the purity of the filled hydrogen. The purity of the filled hydrogen may be expressed quantitatively as a percentage purity (e.g., 99.999% H₂), in parts per million (ppm) for specific impurities (e.g., less than 0.2 ppm CO), according to ISO 14687 standards for allowable impurity levels, or by grade classification (e.g., Grade 5.0 for 99.999% pure hydrogen). In response to determination that the purity of the hydrogen is poor (e.g., not satisfying a threshold level of purity), the processor 100 may open the purge valve 40 to discharge the residual hydrogen in the fuel cell 10. The processor 100 may forcibly discharge defective hydrogen (e.g., hydrogen not satisfying a threshold level of purity) to prevent output characteristics of the fuel cell 10 from being degraded due to the defective hydrogen.

Hereinafter, a process in which the processor 100 determines the defective hydrogen in the fuel cell 10 and discharges the defective hydrogen will be described below.

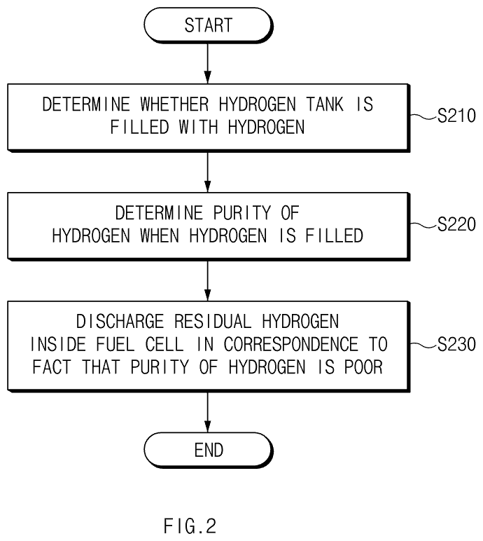

FIG. 2 shows an example of a method of controlling the fuel cell system according to the example of the present disclosure. A procedure shown in FIG. 2 may be a procedure controlled by the processor 100 shown in FIG. 1. One, some, or all steps of the example method of FIG. 2, or portions thereof, may be performed by one or more other circuits. One or some, steps of the example method of FIG. 2 may be omitted, performed in other orders, and/or otherwise modified, and/or one or more additional steps may be added.

Referring to FIGS. 1 and 2, a method of controlling the fuel cell system according to the example of the present disclosure will be described below.

In operation S210, the processor 100 may determine whether the hydrogen tank 20 is filled with the hydrogen.

A process of filling the hydrogen tank 20 with the hydrogen may be performed in a state in which the vehicle is turned off. The processor 100 may determine whether the hydrogen tank 20 is filled with the hydrogen before the vehicle is started up in response to a start-up signal of the vehicle. To this end, the processor 100 may identify or determine a pressure of the hydrogen tank 20 in response to the start-up signal of the vehicle. The processor 100 may obtain the pressure of the hydrogen tank 20 based on a pressure of a supply line for supplying the hydrogen from the hydrogen tank 20 to the fuel cell 10.

The processor 100 may determine that the hydrogen tank 20 is filled with the hydrogen based on the fact that the pressure of the hydrogen tank 20 after the start-up signal is greater than or equal to the pressure of the hydrogen tank 20 before the start-up signal by a threshold pressure (e.g., between 350 bar (5,000psi) and 700 bar (10,000 psi).

Alternatively or additionally, if a device is provided to count the number of times the hydrogen tank 20 is filled with the hydrogen, the processor 100 may determine a hydrogen filled state by identifying the number of times the hydrogen tank 20 is filled with the hydrogen.

In operation S220, in correspondence to the fact that the hydrogen tank 20 is filled with the hydrogen, the processor 100 may determine the purity of the hydrogen stored in the hydrogen tank 20 based on an output voltage of the fuel cell 10.

The processor 100 may determine that the purity of the hydrogen is poor (a percentage purity being lower than a threshold level of purity (e.g., 99.9% H₂) based on the fact that a voltage obtained by subtracting the output voltage of the fuel cell 10 from a reference voltage is less than or equal to a threshold voltage. The reference voltage may be determined based on a state of health (SOH) of the fuel cell 10 before the hydrogen is filled.

In operation S230, in correspondence to the fact that the purity of the hydrogen stored in the hydrogen tank 20 is poor or unsatisfactory, the processor 100 may open the purge valve 40 for discharging the residual hydrogen in the fuel cell 10.

The processor 100 may open the purge valve 40 to discharge impurities inside the fuel cell 10 together with the hydrogen. Accordingly, even if the purity of the hydrogen tank 20 is poor, the fuel cell 10 may continuously receive the hydrogen and thus maintain a stable output.

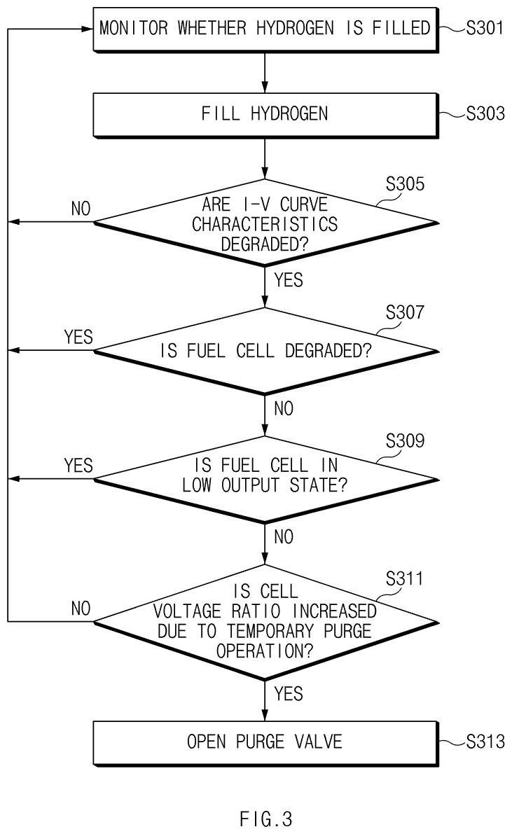

FIG. 3 shows an example of a method of controlling a fuel cell system according to another example of the present disclosure. FIG. 3 shows a detailed example of a condition proceeding to operation S230 shown in FIG. 2. A procedure shown in FIG. 3, may be a procedure controlled by the processor 100. One, some, or all steps of the example method of FIG. 3, or portions thereof, may be performed by one or more other circuits. One or some, steps of the example method of FIG. 3 may be omitted, performed in other orders, and/or otherwise modified, and/or one or more additional steps may be added.

Referring to FIGS. 1 and 3, the method of controlling a fuel cell system according to another example of the present disclosure will be described below.

In operation S301, the processor 100 may monitor whether the hydrogen tank 20 is filled with the hydrogen.

In operation S303 and operation S305, the processor 100 may determine whether current-voltage (I-V) curve characteristics are degraded based on the fact that the hydrogen is filled. An I-V curve is a graphical representation of the relationship between the electric current (I) flowing through a device or material and the voltage (V) applied across it. The I-V curve may be used in analyzing behavior of involved electrical components. The degraded I-V curve characteristics may indicate increased resistance in resistive components, decreased efficiency in diodes or transistors, reduced power output, a shift in the threshold voltage of semiconductor devices, or lower current output due to wear, overheating, or aging in the involved electrical components. The procedure for determining whether the I-V curve characteristics are degraded may be a procedure for determining whether the output characteristics of the fuel cell is degraded.

If the output characteristics of the fuel cell 10 is degraded, a voltage may be decreased at the same current. Based on this, the processor 100 may determine that the output characteristics of the fuel cell 10 is degraded based on the fact that the output voltage of the fuel cell 10, which is obtained after the hydrogen is filled, is smaller than the reference voltage before the hydrogen is filled by the threshold voltage. The reference voltage may be obtained based on an I-V curve of the fuel cell 10 in a state before the hydrogen is filled.

In operation S307, the processor 100 may determine a degradation state of the fuel cell 10 based on the determination that the purity of the hydrogen is poor or unsatisfactory.

The processor 100 may determine the degradation state of the fuel cell 10 based on a cell voltage ratio. The cell voltage ratio means a magnitude of a minimum cell voltage compared to a magnitude of an average cell voltage and may be obtained based on [Equation 1].

$$V\_ratio = \frac{V\_m}{V\_a} \qquad [ Equation 1 ]$$

In [Equation 1], V_ratio may mean the cell voltage ratio. V_m may mean a minimum cell voltage and may mean the smallest voltage among cell voltages of the fuel cell 10. V_a may mean an average cell voltage and may be obtained by dividing a total voltage of the fuel cell 10 by the number of cells.

As the cell voltage ratio becomes closer to 1, it is determined that a current state is ideal, and the cell voltage ratio may be reduced due to the poor purity of the hydrogen and the degradation of the fuel cell 10. A degree to which the cell voltage ratio is reduced may be more affected by the degradation of the fuel cell 10 than the poor purity of the hydrogen. Thus, the degradation of the purity quality of the hydrogen and the degradation of the fuel cell 10 may be distinguished based on the cell voltage ratio. For example, the processor 100 may determine that the fuel cell 10 is in a degradation state based on the fact that the cell voltage ratio is greater than or equal to a threshold ratio. The threshold ratio may be set at a level at which the degradation of the purity quality of the hydrogen and the degradation of the fuel cell 10 may be distinguished.

In operation S307, the processor 100 may monitor whether the hydrogen is filled while maintaining the purge valve 40 in a closed state based on the determination that the fuel cell 10 is in a degraded state. In operation S307, if it is determined that the output characteristics are degraded due to the degradation of the fuel cell 10, a subsequent procedure corresponding to the poor purity of the hydrogen may be stopped.

In operation S309, the processor 100 may determine whether the fuel cell 10 is in a low output state in correspondence to the determination that the fuel cell 10 is not in the degraded state.

The processor 100 may determine the low output state based on the fact that the output current of the fuel cell 10 is smaller than or equal to a threshold current.

In operation S309, the processor 100 may monitor whether the hydrogen is filled while maintaining the purge valve 40 in a closed state based on the determination that the fuel cell 10 is in the low output state. If the fuel cell 10 is in the low output state, the output characteristics may not be accurately determined. In operation S309, in a state in which it is difficult to accurately determine the output characteristics of the fuel cell 10, a subsequent procedure corresponding to the poor purity of the hydrogen may be stopped.

In operation S311, the processor 100 may determine whether the cell voltage ratio is increased due to a temporary purge operation.

In operation S311, a change in the cell voltage ratio due to the purge operation may be comparison between a first cell voltage ratio in a state in which the purge valve 40 is open and a second cell voltage ratio in a state in which the purge valve 40 is closed. The first cell voltage ratio and the second cell voltage ratio may be obtained based on [Equation 1] as described above.

The first cell voltage ratio is obtained in a state in which the purge valve 40 is open and thus may be determined as a cell voltage ratio resulting from the purge operation.

The cell voltage ratio may be reduced if the purity of the hydrogen is poor, and if the purge valve 40 is opened in a state in which the purity of the hydrogen is poor, the cell voltage ratio may be increased again. Further, if the purge valve 40 is closed again in a state in which the purity of the hydrogen is poor, the cell voltage ratio may be reduced.

Thus, the processor 100 may determine whether the purity of the hydrogen is poor based on a difference between the first cell voltage ratio and the second cell voltage ratio. For example, the processor 100 may obtain a cell voltage ratio deviation by subtracting the second cell voltage ratio from the first cell voltage ratio and compare the cell voltage ratio deviation with a threshold value. The processor 100 may determine that the purity of the hydrogen is poor based on the fact that the cell voltage ratio deviation is greater than or equal to the threshold value.

Further, the processor 100 may determine that the purity of the hydrogen is poor based on the fact that the first cell voltage ratio is greater than the second cell voltage ratio. For example, the processor 100 may determine that the purity of the hydrogen is poor if the difference between the first cell voltage ratio and the second cell voltage ratio is greater than or equal to a second threshold value. That is, the processor 100 may identify whether the purity of the hydrogen is poor again through operation S311. In operation S313, the processor 100 may open the purge valve 40 based on the fact that it is identified that the purity of the hydrogen is poor in operation S311.

Hereinafter, a detailed example of the method of controlling a fuel cell system according to the present disclosure will be described.

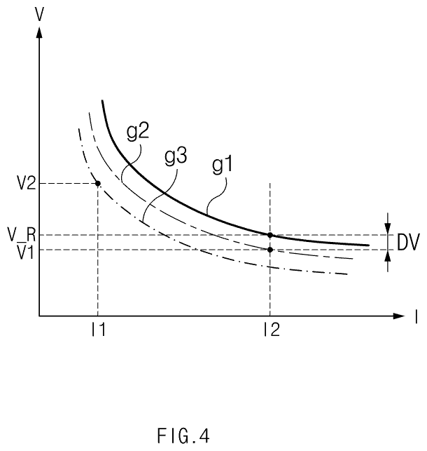

FIG. 4 shows an example of determining the purity of hydrogen based on an output voltage of a fuel cell.

Referring to FIG. 4, the processor 100 may determine the purity of the hydrogen based on a current-voltage relationship (hereinafter, referred to as an I-V curve) representing the output characteristics of the fuel cell 10.

A reference I-V curve g1 may be adapted to determine whether the output characteristics of the fuel cell 10 is in a degraded state and may represent current-voltage characteristics according to an aging degree of the fuel cell 10 in a reference driving period. The reference driving period may mean a driving period during which the fuel cell 10 is driven most recently, and the driving period may mean a period divided by starting up or turning off an engine of the vehicle. For example, the reference driving period may mean a period during which the fuel cell 10 is most recently driven before the start-up signal of the vehicle.

The processor 100 may search for the aging degree of the fuel cell 10 in the reference driving period. To this end, the processor 100 may identify the aging degree of the fuel cell 10 at regular time intervals and store the identified aging degree in a memory. The processor 100 may extract an I-V curve that matches the aging degree in the reference driving period and use the extracted I-V curve as the reference I-V curve.

After identifying the start-up signal, the processor 100 may identify the output current of the fuel cell 10 and the output voltage of the fuel cell 10. The output current of the fuel cell 10 may be obtained by the current sensor 62, and the output voltage of the fuel cell 10 may be obtained by the voltage sensor 63.

For example, if the output current of the fuel cell 10 obtained at a first timing is I1 and the output voltage thereof is V2, it is determined that the fuel cell 10 exhibits output characteristics of a third I-V curve g3. Alternatively or additionally, if the output current of the fuel cell 10 obtained at a second timing is I2 and the output voltage thereof is V1, it is determined that the fuel cell 10 exhibits output characteristics of a second I-V curve g2.

The second I-V curve g2 and the third I-V curve g3 may mean I-V curves in which the output characteristics of the fuel cell 10 are reduced.

The processor 100 may compare a measured voltage and the reference voltage to determine whether the I-V curve of the fuel cell 10 has degraded output characteristics after the vehicle is started up as compared to the reference I-V curve g1. The measured voltage may be an output voltage of the fuel cell 10, which is measured after the vehicle is started up, and for example, V1 obtained at the second timing may be the measured voltage. The reference voltage may be a voltage matched with a measured current in the reference I-V curve g1, and for example, the reference voltage at the second timing may be V_R.

The processor may 100 determine output the characteristics of the fuel cell 10 by comparing the threshold voltage with a magnitude obtained by subtracting the measured voltage from the reference voltage. For example, the processor 100 may determine that the output characteristics of the fuel cell 10 are degraded if a DV shown in FIG. 4 is greater than or equal to a preset threshold voltage.

The processor 100 may determine that the purity of the hydrogen supplied to the fuel cell 10 is poor based on the fact that the output characteristics of the fuel cell 10 are degraded. The poor purity of the hydrogen may mean that the purity of the hydrogen after the hydrogen is filled in the hydrogen tank 20 is lower than the purity of the hydrogen before the hydrogen is filled in the hydrogen tank 20.

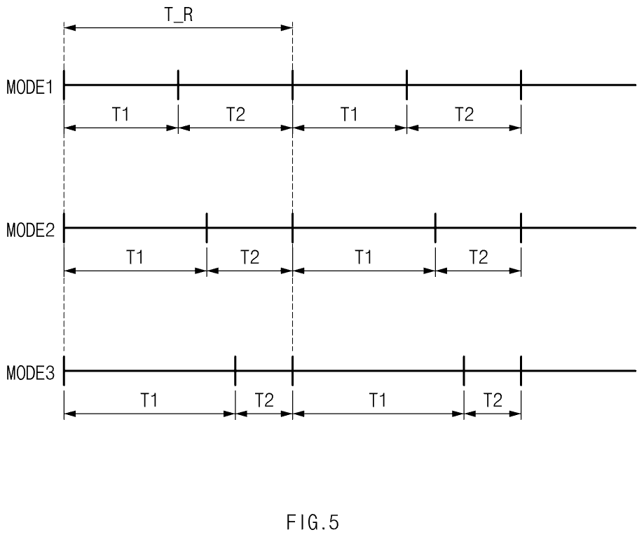

FIG. 5 shows an example of an open ratio of a purge valve according to the example of the present disclosure. FIG. 5 is adapted to describe a detailed example of operation S230 shown in FIG. 2 or operation S313 shown in FIG. 3.

Referring to FIG. 5, the processor 100 may open the purge valve 40 during a first period T1 and close the purge valve 40 during a second period T2 within one cycle T_R.

A ratio of the first period T1 and the second period T2 may change depending on an operation mode. For example, the operation mode may include a first mode mode1 to a third mode mode3, and the processor 100 may control opening of the purge valve 40 by selecting any one operation mode from the first mode mode1, the second mode mode2, or the third mode mode3. The number of operation modes is not limited to the example shown in FIG. 5 and may be set to two or more.

The one cycle T_R of the first mode mode1 to the third mode mode3 may be the same.

Further, in the respective modes mode1, mode2, and mode3, the first periods T1 may be different from each other, and the second periods T2 may be different from each other. For example, the first period T1 of the first mode mode1 and the first period T1 of the second mode mode2 may be different from each other.

The processor 100 may select any one of the first mode mode1 to the third mode mode3 depending on a poor degree of the purity of the hydrogen. For example, the processor 100 may select an operation mode in which a width of the first period T1 is increased as the poor degree of the purity of the hydrogen becomes more severe. In FIG. 4, the processor 100 may determine that the poor degree of the purity of the hydrogen becomes more severe as the magnitude DV obtained by subtracting the measured voltage from the reference voltage becomes greater.

As in the previous example, the poor degree of the purity of the hydrogen may be determined based on the first cell voltage ratio and the second cell voltage ratio. The first cell voltage ratio may be a cell voltage ratio if the purge valve 40 is open, and the second cell voltage ratio may be a cell voltage ratio if the purge valve 40 is closed.

The processor 100 may determine the operation mode of the purge valve 40 based on the difference between the first cell voltage ratio and the second cell voltage ratio.

A degree to which the I-V performance is degraded may be divided into stages according to the magnitude DV obtained by subtracting the measured voltage from the reference voltage, and the memory may store a table in which the operation mode of the purge valve 40 is matched according to the degree to which the I-V performance is degraded. The processor 100 may select the operation mode of the purge valve 40 according to the magnitude DV obtained by subtracting the measured voltage from the reference voltage.

Further, the processor 100 may set the width of the first period T1 to be greater as a speed of the vehicle is increased. As the width of the first period T1 is increased, the poor purity of the hydrogen may be improved, but the amount of hydrogen discharged to the outside of the vehicle may be limited in consideration of an environment. If the speed of the vehicle is high (e.g., higher than a given threshold speed), even if the same amount of hydrogen is discharged, the hydrogen is discharged over a wider area, and thus the amount of hydrogen discharged may be increased.

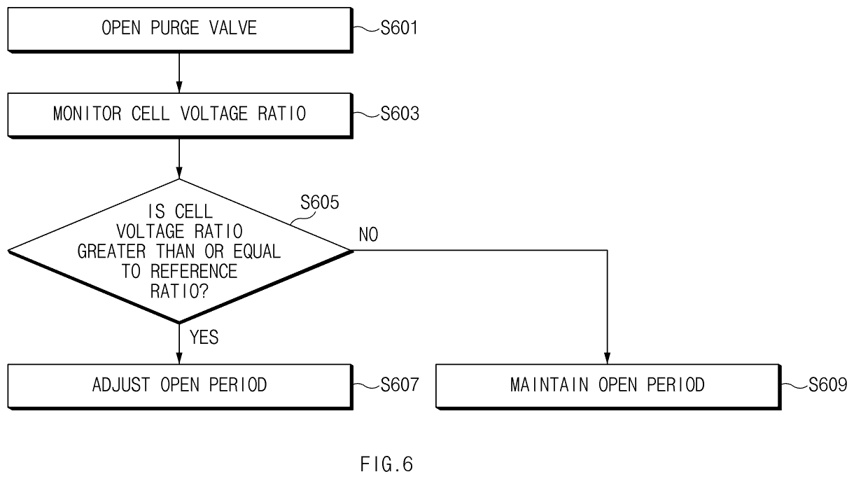

FIG. 6 shows an example of the method of controlling the fuel cell system according to another example of the present disclosure. Referring to FIG. 6, the method of controlling a fuel cell system according to another example of the present disclosure will be described below. One, some, or all steps of the example method of FIG. 6, or portions thereof, may be performed by one or more other circuits. One or some, steps of the example method of FIG. 6 may be omitted, performed in other orders, and/or otherwise modified, and/or one or more additional steps may be added.

In operation S601, the processor 100 may open the purge valve 40 to remove residual hydrogen inside the fuel cell 10. Operation S601 may be operation S230 shown in FIG. 2 or operation S313 shown in FIG. 3.

In operation S603, the processor 100 may monitor the cell voltage ratio. The processor 100 may acquire the cell voltage ratio based on [Equation 1] as described above.

In operation S605, the processor 100 may determine whether the cell voltage ratio is greater than or equal to a reference ratio.

That is, the processor 100 may determine whether the cell voltage ratio is increased due to the purge operation.

In operation S607, the processor 100 may adjust an opening period of the purge valve 40 based on the fact that it is identified that the cell voltage ratio is greater than or equal to the reference ratio.

The processor 100 may determine that the purity of the hydrogen is increased if the cell voltage ratio is increased. Thus, the processor 100 may reduce the opening period of the purge valve 40. The example shown in FIG. 5 may be used to adjust the opening period of the purge valve 40. For example, if it is identified that the cell voltage ratio is greater than or equal to the reference ratio in a state in which the purge valve 40 is controlled in the second mode mode2, the processor 100 may control the purge valve 40 in the first mode mode1.

In operation S605, if it is identified that the cell voltage ratio is smaller than the reference ratio, the processor 100 may proceed to operation S609 to maintain the opening period.

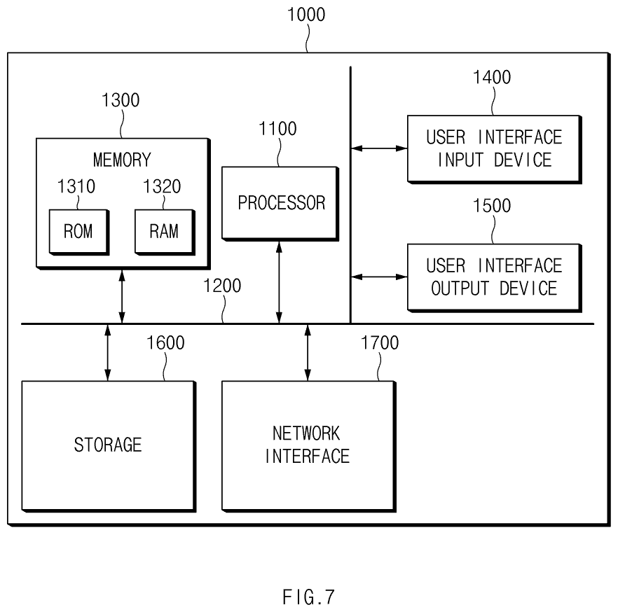

FIG. 7 illustrates a computing system according to the example of the present disclosure.

Referring to FIG. 7, a computing system 1000 may include at least one processor 1100, a memory 1300, a user interface input device 1400, a user interface output device 1500, a storage 1600, and a network interface 1700, which are connected through a bus 1200.

The processor 1100 may be a central processing unit (CPU) or a semiconductor device that processes commands stored in the memory 1300 and/or storage 1600. The memory 1300 and the storage 1600 may include various types of volatile or nonvolatile storage media. For example, the memory 1300 may include a read only memory (ROM) and a random access memory (RAM).

Thus, operations of a method or algorithm described in connection with the examples disclosed herein may be directly implemented in hardware, a software module, or a combination of the two components, which are executed by the processor 1100. The software module may reside in a storage medium (that is, the memory 1300 and/or the storage 1600) such as a RAM, a flash memory, a ROM, an EPROM, an EEPROM, a register, a hard disk, a removable disk, and a compact disk (CD)-ROM.

An exemplary storage medium may be coupled to the processor 1100, and the processor 1100 may read information from the storage medium and write information in the storage medium. In another manner, the storage medium may be integrated with the processor 1100. The processor and the storage medium may reside inside an application-specific integrated circuit (ASIC). The ASIC may reside inside a user terminal. In still another manner, the processor and the storage medium may reside as an individual component inside the user terminal.

The present disclosure has been made to solve the above-mentioned problems occurring in the prior art while advantages achieved by the prior art are maintained intact.

An example of the present disclosure provides a fuel cell system for preventing continuous supply of hydrogen having poor purity to a fuel cell of a hydrogen electric vehicle, and a method of controlling the same.

Another example of the present disclosure provides a fuel cell system that determines whether purity of hydrogen in a hydrogen tank is poor to prevent shutdown of the fuel cell system due to a decrease in the purity of the hydrogen supplied to a fuel cell, and a method of controlling the same.

The technical problems to be solved by the present disclosure are not limited to the aforementioned problems, and any other technical problems not mentioned herein will be clearly understood from the following description by those skilled in the art to which the present disclosure pertains.

According to an example of the present disclosure, there is provided a fuel cell system including a hydrogen tank that stores hydrogen provided to a fuel cell, a sensor device that measures an output current and a voltage of the fuel cell, and a processor that determines whether the hydrogen tank is in a filled state of being filled with the hydrogen, determines purity of the hydrogen stored in the hydrogen tank based on an output voltage of the fuel cell that receives the hydrogen in correspondence to the identified filled state, and opens a purge valve for discharging residual hydrogen in the fuel cell in correspondence to the determination that the purity of the hydrogen is poor.

According to an example, the processor may identify a pressure of the hydrogen tank in response to a start-up signal of a vehicle and determine the filled state based on a fact that the pressure of the hydrogen tank is greater than or equal to a pressure before the start-up signal by a threshold pressure.

According to an example, the processor may identify the output current of the fuel cell and the voltage of the fuel cell after a start-up signal and determine that the purity of the hydrogen is poor based on a fact that a magnitude obtained by subtracting the voltage of the fuel cell from a reference voltage is smaller than or equal to a threshold voltage.

According to an example, the processor may determine a most recent driving period of the fuel cell before the start-up signal as a reference driving period, determine an aging degree of the fuel cell within the reference driving period as a reference aging degree, acquire a reference current-voltage relationship by modeling a current-voltage relationship of the fuel cell based on the reference aging degree, and determine, as the reference voltage, a voltage matched with a magnitude of the output current of the fuel cell after the start-up signal in the reference current-voltage relationship.

According to an example, the threshold voltage may be set within a range greater than a voltage difference between an initial timing and a termination timing of a lifetime of the fuel cell.

According to an example, the processor may determine a ratio of an open period to a closed period of the purge valve according to a voltage difference that is a result obtained by subtracting the voltage of the fuel cell from the reference voltage.

According to an example, the processor may set the ratio of the open period of the purge valve to be great in proportion to a vehicle speed.

According to an example, the processor may monitor a cell voltage ratio that represents a magnitude of a minimum cell voltage compared to an average cell voltage of the fuel cell and reduce the ratio of the open period of the purge valve based on a fact that the cell voltage ratio is greater than or equal to a reference ratio.

According to an example, the processor may determine a first cell voltage ratio, which represents a magnitude of a minimum cell voltage compared to an average cell voltage of the fuel cell, in a state in which the purge valve is open, determine a second cell voltage ratio, which represents the magnitude of the minimum cell voltage compared to the average cell voltage of the fuel cell, in a state in which the purge valve is closed, and determine that the purity of the hydrogen stored in the hydrogen tank is poor based on a fact that a difference between the first cell voltage ratio and the second cell voltage ratio is greater than or equal to a threshold value.

According to an example, the processor may determine whether the fuel cell is degrade based on a magnitude of a minimum cell voltage compared to an average cell voltage of the fuel cell and maintain the purge valve in a closed state in correspondence to a fact that the fuel cell is degraded.

According to an example, the processor may maintain the purge valve in a closed state based on a fact that the output current of the fuel cell is smaller than or equal to a threshold output.

According to another example of the present disclosure, there is provided a method of controlling a fuel cell system, the method including determining, by a processor, whether a hydrogen tank is in a filled state of being filled with hydrogen, determining, by the processor, purity of the hydrogen stored in the hydrogen tank based on an output voltage of a fuel cell that receives the hydrogen in correspondence to the identified filled state, and opening, by the processor, a purge valve for discharging residual hydrogen in the fuel cell in correspondence to the determination that the purity of the hydrogen is poor.

According to an example, the determining of the purity of the hydrogen may include identifying an output current of the fuel cell and a voltage of the fuel cell after a start-up signal, and determining that the purity of the hydrogen is poor based on a fact that a magnitude obtained by subtracting the voltage of the fuel cell from a reference voltage is smaller than or equal to a threshold voltage.

According to an example, the determining of the purity of the hydrogen may further include determining a most recent driving period of the fuel cell before the start-up signal as a reference driving period, determining an aging degree of the fuel cell within the reference driving period as a reference aging degree, acquiring a reference current-voltage relationship by modeling a current-voltage relationship of the fuel cell based on the reference aging degree, and determining, as the reference voltage, a voltage matched with a magnitude of the output current of the fuel cell after the start-up signal in the reference current-voltage relationship.

According to an example, in the determining of the purity of the hydrogen, the threshold voltage set within a range greater than a voltage difference between an initial timing and a termination timing of a lifetime of the fuel cell may be used.

According to an example, the opening of the purge valve from the fuel cell may include determining a purge period ratio that represents a ratio of an open period to a closed period of the purge valve based on the magnitude obtained by subtracting the voltage of the fuel cell from the reference voltage.

According to an example, the determining of the purity of the hydrogen may include determining a first cell voltage ratio, which represents a magnitude of a minimum cell voltage compared to an average cell voltage of the fuel cell, in a state in which the purge valve is open, determining a second cell voltage ratio, which represents the magnitude of the minimum cell voltage compared to the average cell voltage of the fuel cell, in a state in which the purge valve is closed, and determining that the purity of the hydrogen stored in the hydrogen tank is poor based on a fact that a difference between the first cell voltage ratio and the second cell voltage ratio is greater than or equal to a threshold value.

According to an example, the opening of the purge valve may include determining a purge period ratio that represents a ratio of an open period to a closed period of the purge valve based on a difference between the first cell voltage ratio and the second cell voltage ratio.

According to an example, the method may further include determining whether the fuel cell is degrade based on a magnitude of a minimum cell voltage compared to an average cell voltage of the fuel cell and maintaining the purge valve in a closed state in correspondence to a fact that the fuel cell is degraded.

According to an example, the method may further include identifying an output current of the fuel cell, and maintaining the purge valve in a closed state based on a fact that the output current of the fuel cell is smaller than or equal to a threshold output.

According to an example of the present disclosure, even if purity of hydrogen in a hydrogen tank of a hydrogen electric vehicle is poor, residual hydrogen in a fuel cell is forcibly discharged, the hydrogen is continuously supplied to the fuel cell, and thus the purity of the hydrogen may be prevented from being degraded.

Further, according to an example of the present disclosure, the purity of the hydrogen is determined at the moment that the hydrogen electric vehicle is started up, and thus a phenomenon in which a fuel cell system is shut down due to a decrease in the purity of the hydrogen may be prevented.

In addition, various effects directly or indirectly identified though the present document may be provided.

The above description is merely illustrative of the technical spirit of the present disclosure, and those skilled in the art to which the present disclosure belongs may make various modifications and changes without departing from the essential features of the present disclosure.

Thus, the examples disclosed in the present disclosure are not intended to limit the technology spirit of the present disclosure but are intended to describe the present disclosure, and the scope of the technical spirit of the present disclosure is not limited by these examples. The scope of protection of the present disclosure should be interpreted by the appended claims, and all technical spirits within the scope equivalent thereto should be interpreted as being included in the scope of the present disclosure.

What is claimed is:

1. A fuel cell system comprising:
a hydrogen tank configured to store hydrogen;
a fuel cell configured to receive, based on a state of the hydrogen tank, the hydrogen from the hydrogen tank;
a sensor configured to measure at least one of an output current or an output voltage of the fuel cell; and
a processor configured to:
determine the state of the hydrogen tank, wherein the state is associated with an amount of hydrogen filled in the hydrogen tank,
determine, based on the output voltage of the fuel cell, a purity level of the hydrogen stored in the hydrogen tank, wherein the output voltage is obtained based on the state of the hydrogen tank; and
open, based on the purity level of the hydrogen being unsatisfactory, a purge valve for discharging residual hydrogen from the fuel cell.

2. The fuel cell system of claim 1, wherein the processor is configured to:
determine, based on a start-up signal of a vehicle, a pressure of the hydrogen tank; and
determine, based on a difference between the pressure of the hydrogen tank and a pressure of the hydrogen tank before the start-up signal being greater than or equal to a threshold pressure, the state of the hydrogen tank.

3. The fuel cell system of claim 1, wherein the processor is configured to:
after a start-up signal of a vehicle, determine the output current of the fuel cell and the output voltage of the fuel cell; and
determine, based on a difference between the output voltage of the fuel cell and a reference voltage being smaller than or equal to a threshold voltage, the purity level of the hydrogen as being unsatisfactory.

4. The fuel cell system of claim 3, wherein the processor is configured to:
determine a last driving period of the fuel cell before the start-up signal as a reference driving period;
determine an aging degree of the fuel cell within the reference driving period as a reference aging degree;
acquire a reference current-voltage relationship by modeling, based on the reference aging degree, a current-voltage relationship of the fuel cell; and
determine, based on the reference current-voltage relationship, the reference voltage, wherein the reference voltage is a voltage matched with a magnitude of the output current of the fuel cell after the start-up signal.

5. The fuel cell system of claim 3, wherein the threshold voltage is greater than a voltage difference between an initial voltage at an initial timing a lifetime of the fuel cell and a termination voltage at a termination timing of the lifetime of the fuel cell.

6. The fuel cell system of claim 3, wherein the processor is configured to determine, based on a voltage difference between the output voltage of the fuel cell and the reference voltage, a ratio of an open period of the purge valve to a closed period of the purge valve.

7. The fuel cell system of claim 6, wherein the processor is configured to increase the ratio of the open period in proportion to a vehicle speed.

8. The fuel cell system of claim 6, wherein the processor is configured to:
monitor a cell voltage ratio of a magnitude of a minimum cell voltage of the fuel cell to a magnitude of an average cell voltage of the fuel cell; and
reduce, based on the cell voltage ratio being greater than or equal to a reference ratio, the ratio of the open period.

9. The fuel cell system of claim 1, wherein the processor is configured to:
in a first state in which the purge valve is open, determine a first cell voltage ratio of a magnitude of a minimum cell voltage of the fuel cell to a magnitude of an average cell voltage of the fuel cell;
in a second state in which the purge valve is closed, determine a second cell voltage ratio of a magnitude of a minimum cell voltage of the fuel cell to a magnitude of an average cell voltage of the fuel cell; and
determine, based on a difference between the first cell voltage ratio and the second cell voltage ratio being greater than or equal to a threshold value, the purity level of the hydrogen as being unsatisfactory.

10. The fuel cell system of claim 1, wherein the processor is configured to:
determine, based on a ratio of a magnitude of a minimum cell voltage of the fuel cell to a magnitude of an average cell voltage of the fuel cell, whether the fuel cell is degraded; and
maintain, based on the fuel cell being degraded, the purge valve in a closed state.

11. The fuel cell system of claim 1, wherein the processor is configured to maintain, based on the output current of the fuel cell being smaller than or equal to a threshold output, the purge valve in a closed state.

12. A method performed by a processor for controlling a fuel cell system, the method comprising:
determining a state of a hydrogen tank, wherein the state is associated with an amount of hydrogen filled in the hydrogen tank;
determining, based on an output voltage of a fuel cell, a purity level of the hydrogen stored in the hydrogen tank, wherein the output voltage is obtained based on the state of the hydrogen tank; and
opening, based on the purity level of the hydrogen being unsatisfactory, a purge valve for discharging residual hydrogen from the fuel cell.

13. The method of claim 12, wherein the determining the purity level of the hydrogen comprises:
after a start-up signal of a vehicle, determining the output current of the fuel cell and an output voltage of the fuel cell; and
determining, based on a difference between the output voltage of the fuel cell and a reference voltage being smaller than or equal to a threshold voltage, the purity level of the hydrogen as being unsatisfactory.

14. The method of claim 13, wherein the determining the purity level of the hydrogen further comprises:
determining a last driving period of the fuel cell before the start-up signal as a reference driving period;
determining an aging degree of the fuel cell within the reference driving period as a reference aging degree;
acquiring a reference current-voltage relationship by modeling, based on the reference aging degree, a current-voltage relationship of the fuel cell; and
determining, based on the reference current-voltage relationship, the reference voltage, wherein the reference voltage is a voltage matched with a magnitude of the output current of the fuel cell after the start-up signal.

15. The method of claim 13, wherein the threshold voltage is greater than a voltage difference between an initial voltage at an initial timing of a lifetime of the fuel cell and a termination voltage at a termination timing of the lifetime of the fuel cell is used.

16. The method of claim 13, wherein the opening the purge valve comprises:
determining, based on a voltage difference between the output voltage of the fuel cell and the reference voltage, a ratio of an open period of the purge valve to a closed period of the purge valve.

17. The method of claim 12, wherein the determining the purity level of the hydrogen comprises:
in a first state in which the purge valve is open, determining a first cell voltage ratio of a magnitude of a minimum cell voltage of the fuel cell to a magnitude of an average cell voltage of the fuel cell;
in a second state in which the purge valve is closed, determining a second cell voltage ratio of a magnitude of a minimum cell voltage of the fuel cell to a magnitude of an average cell voltage of the fuel cell; and
determining, based on a difference between the first cell voltage ratio and the second cell voltage ratio being greater than or equal to a threshold value, the purity level of the hydrogen as being unsatisfactory.

18. The method of claim 17, wherein the opening the purge valve comprises:
determining, based on a difference between the first cell voltage ratio and the second cell voltage ratio, a ratio of an open period of the purge valve to a closed period of the purge valve.

19. The method of claim 12, further comprising:
determining, based on a ratio of a magnitude of a minimum cell voltage of the fuel cell to a magnitude of an average cell voltage of the fuel cell, whether the fuel cell is degraded; and
maintaining, based on the fuel cell being degraded, the purge valve in a closed state.

20. The method of claim 12, further comprising:
determining an output current of the fuel cell; and
maintaining, based on the output current of the fuel cell being smaller than or equal to a threshold output, the purge valve in a closed state.
